(19) United States
(12) Patent Application Publication
(10) Pub. No.: US 2026/0220294 A1
(43) Pub. Date: Jul. 30, 2026

(54) FEATURE POLICIES

(71) Applicant: Snowflake Inc., Bozeman, MT (US)

(72) Inventors: Damien Carru, New York, NY (US); Benoit Dageville, San Mateo, CA (US); Scott C. Gray, Richmond Hill (CA)

(21) Appl. No.: 19/039,957

(22) Filed: Jan. 29, 2025

(51) Int. Cl. G06F 21/62

(52) U.S. Cl. CPC G06F 21/6227

(57) ABSTRACT

Feature policies can control different aspects of features, such as creation of new objects, to provide fine-grained restrictions on how the features may be used. Feature policies are system policies that allow users to control creation of features within a given context, such as at the entire account level, specific database level, specific schema level, etc. Feature policies can be independent objects that can be bound and unbound to different hierarchical levels of an account. Multiple feature policies can be concurrently enforced.

### TECHNICAL FIELD

Embodiments of the disclosure relate generally to cloud data platforms and, more specifically, to providing control of features, such as creation of new database objects.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may include one or more databases that are respectively maintained in association with any number of customer accounts. An account may have a number of different users, and it may be difficult to control what the users are allowed to do, such as creating new objects, in the data platform.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a cloud data platform, according to some example embodiments.

FIG. 2 is a block diagram illustrating components of a compute service manager of the cloud data platform, according to some example embodiments.

FIG. 3 depicts an example of a framework for feature policies, according to some example embodiments.

FIG. 4 is a flow diagram of method for providing a feature policy, according to some example embodiments.

FIG. 5 is a flow diagram of method or enforcing feature policies, according to some example embodiments.

FIG. 6 depicts an example of a framework for providing and sharing an application, according to some example embodiments.

FIG. 7 is a flow diagram of a method for enforcing feature policies with applications, according to some example embodiments.

FIG. 8 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

A data platform (or cloud data platform or multi-tenant network-based data system), as described in further detail below may include a plurality of different accounts. Each account may include a plurality of different users. From time to time, the data platform may release new features or changes to already existing features. The new features can include new objects, such as new schema level objects and account level objects. Some more advanced objects may also be introduced, which may require provisioning of objects in respective accounts to optimize user experience.

For account holders, it can be challenging to control what users of the account can and cannot do, such as creating new objects. For example, some account holders may have a lengthy security review process for any new feature introduced by the data platform, which can lead to slow adoption of the new features. In some systems, role-based access control (RBAC) can be used to restrict activity based on the roles of the user. However, RBAC is typically used for already-created features and not new features. Furthermore, an account may have a large number of roles, and RBAC rules have to be specifically provisioned for each role. Therefore, RBAC alone cannot handle broad, hierarchical control of new features in a data platform.

Feature policies, as described in further detail below, can provide broad, hierarchical control of features. Feature policies can control different aspects of features, such as creation of new objects, to provide fine-grained restrictions on how the features may be used. Feature policies are system policies that allow users to control creation of features within a given context, such as at the entire account level, specific database level, specific schema level, etc. Feature policies can be independent objects that can be bound and unbound to different hierarchical levels of an account. Multiple feature policies can be concurrently enforced.

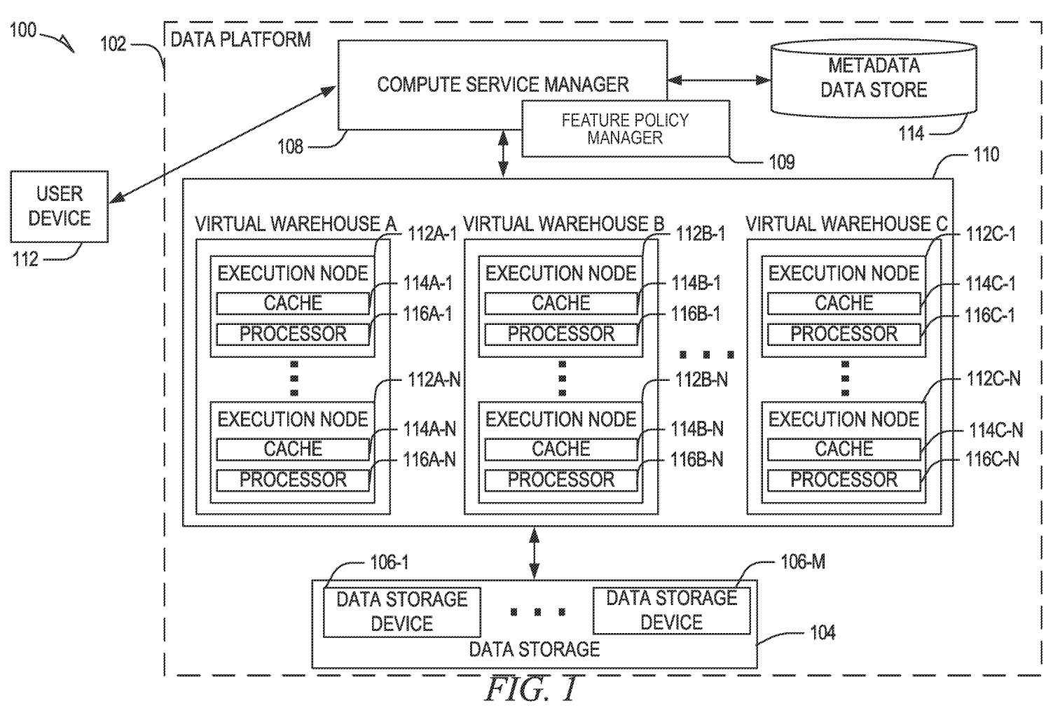

FIG. 1 illustrates an example computing environment 100 that includes a cloud data platform 102, according to some example embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 113, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as "virtual warehouses"). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 113. The metadata data store 113 stores metadata pertaining to various functions and aspects associated with the cloud data platform 102 and its users. The metadata data store 113 also includes a summary of data stored in data storage 104 as well as data available from local caches. Additionally, the metadata data store 113 includes information regarding how data is organized in the data storage 104 and the local caches.

As shown, the compute service manager 108 includes a feature policy manager 109 that is responsible for managing feature policies. Feature policies system policies that allow users to control creation of specific data system features within a given context, such as at the entire account level, specific database level, specific schema level, etc. Further details of the operation of the feature policy manager 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 113. The metadata data store 113 stores metadata pertaining to various functions and aspects associated with the cloud data platform 102 and its users. The metadata data store 113 also includes a summary of data stored in data storage 104 as well as data available from local caches. Additionally, the metadata data store 113 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B- 1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S₃^{TM} storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®)

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources.

Similarly, this decoupling of resources supports a significant increase in the computing resources utilized at a particular time without requiring a corresponding increase in the available data storage resources

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 113 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 113, execution platform 110, and data storage 104 are shown in FIG. 1 as individual discrete components. However, each of the compute service manager 108, metadata data store 113, execution platform 110, and data storage 104 may be implemented as a distributed system (e.g., distributed across multiple systems/platforms at multiple geographic locations). Additionally, each of the compute service manager 108, metadata data store 113, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

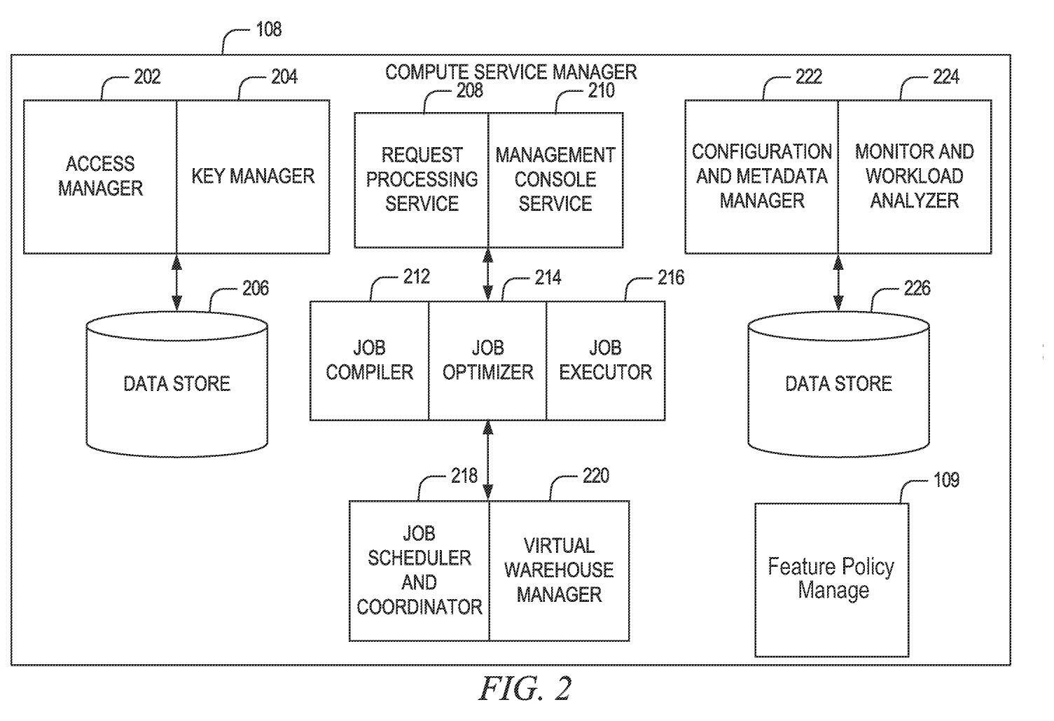

FIG. 2 is a block diagram illustrating components of the compute service manager 108, according to some example embodiments. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., "external") query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 113, or any other storage device or system

In addition, as mentioned above, the compute service manager 108 includes a feature policy manager 109 that is responsible for managing feature policies. Feature policies system policies that allow users to control creation of specific data system features within a given context, such as at the entire account level, specific database level, specific schema level, etc. Further details of the operation of the feature policy manager 109 are discussed below.

In a multi-tenant data system, as described above, new features can be released by the data system. However, some users in the multi-tenant data system may have lengthy review processes for new objects to ensure that the new objections comply with their security protocols, which can lead to slow adoption of the new features. In conventional systems, there is a lack of broad, hierarchical control of object creation.

Feature policies are system policies that allow users to control creation of specific data system features within a given context, such as at the entire account level, specific database level, specific schema level, etc. Feature policies can control different aspects of features, such as creation, to provide fine-grained restrictions on how the features may be used. Unlike RBAC or conventional deny grants, feature policies provide broad, hierarchical control of features, such as object creation.

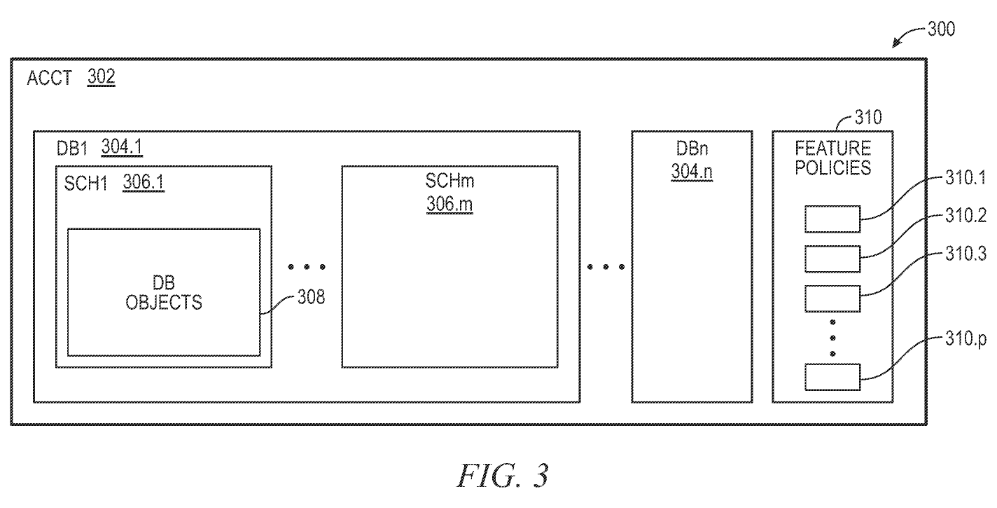

FIG. 3 depicts an example of a framework 300 for feature policies, according to some example embodiments. Framework 300 is for an account 302 in a multi-tenant data system as described above. The account 302 may be organized in a hierarchical fashion. The account 302 may include one or more databases (DB1-DBn) 304.1-304.n. Each database of DB1-DBn304.1-304.n may include one or more schemas. For example, DB1304.1 may include one or more schemas (SCH1 - SCHm) 306.1-306.m. Each schema may include one or more database objects 308, such as tables, materialized views, etc. For example, SCH1306.1 may include one or more database objects 308.

Feature policies 310 may be provided as separate account-level objects in account 302. In the example of FIG. 3, feature policies 310.1-310.p are provided. Each feature policy may indicate what objects can or cannot be created in a respective hierarchical level of the account 302, such as account level, specific database level, etc. A feature policy 310.1-310.p may define a set of object types whose creation can be blocked or allowed. In some examples, a feature policy can define blocked object types, which is a list of objects types that cannot be created in the object (i.e., account hierarchical level) to which the policy is bound. Additionally or alternatively, a feature policy can define allowed object types, which is a list of object types that can be created in the object to which the policy is bound.

In some examples, the lists (e.g., allowed and/or block lists) may include specific types of objects, providing a fine-grained control solution for different types of objects. For example, the block list in a feature policy may include types of table data, which may block creation of objects such as tables, views, materialized views, etc. In another example, the block list in a feature policy may include types of background activity, which may block creation of objects such as tasks, materialized views, dynamic tables, etc. In another example, the block list in a feature policy may include types of databases, which may block creation of certain types of databases, such as personal databases, shared databases.

The feature policies 310.1-310.p may be independent policy objects that can be bound or unbound to different hierarchical levels of account 302. For example, feature policy 310.1 may define a list of blocked objects for the entire account 302. Feature policy 310.1 may then be bound to account 302 by a specified user of account 302 (e.g., administrator). However, the user, at a later time, may wish to attach a different account-level feature policy to account 302. The user may unbind feature 310.1 from account 302, and may then bind feature policy 310.2 to account 302, which may include a new list of blocked objects for the entire account 302.

As mentioned above, feature policies 310.1-310.p may be provided for different account hierarchical levels (e.g., databases, schemas, etc.). For example, feature policy 310.3 may define a list of blocked objects on a database level and may be bound to DB 1304.1. A plurality of feature policies may be bound to respective hierarchical levels and may be enforced in conjunction, as described in further detail below.

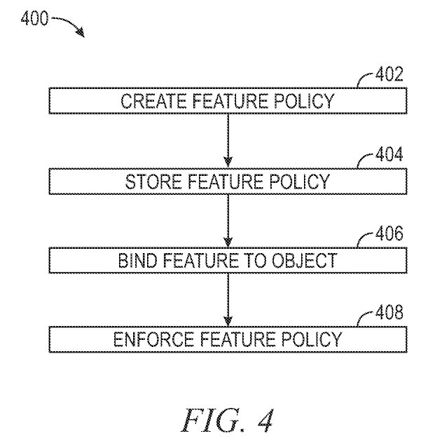

FIG. 4 is a flow diagram of method 400 for providing a feature policy, according to some example embodiments. At operation 402, a feature policy is created. In some examples, a user of an account may create a feature policy defining a list of objects whose creation is blocked (and/or allowed) at a particular hierarchical level of the account. For example, the feature policy may include a list of object types, such as database (or type of database, such as personal or shared), table, schema, application, secret, pipe, task, or compute pool, whose creation is to be blocked. In some examples, the data system may create template feature policies that can be adopted and used by different users of the multi-tenant data system.

At operation 404, the feature policy is stored as an account-level object in the multi-tenant data system. For example, the feature policy may be stored in a metadata database as described herein. As described above, the feature policy is an independent policy object that is not dependent on other objects in the account.

At operation 406, the feature policy is bound to an object (i.e., hierarchical level) in the account. For example, a user of the account may bind the feature policy to the entire account, thus blocking (and/or allowing) the creation of the list of objects in the feature policy in the entire account. In another example, the feature policy may be bound to a specific object (e.g. a database), thus blocking (and/or allowing) the creation of the list of objects in the feature policy in the specified database. The feature policy may be bound to the specified object by a user with appropriate permissions for the specified object.

At operation 408, the feature policy is enforced. The feature policy may be enforced when an object is requested to be created or if the object is already created, the feature policy may enforce whether the object can access another object. Concurrent enforcement of multiple feature policies is described in further detail below.

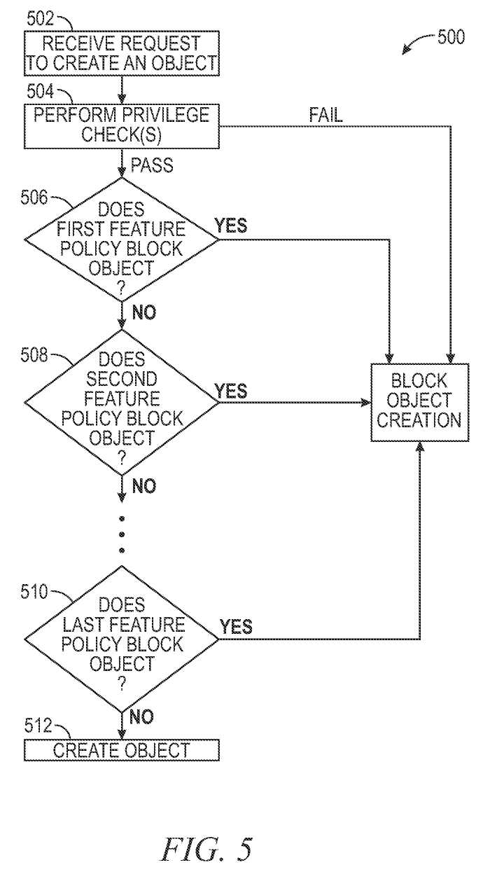

FIG. 5 is a flow diagram of method 500 for enforcing feature policies, according to some example embodiments. As mentioned above, one or more feature policies may be bound to different hierarchical levels associated with an account. Enforcement of the respective feature policies may be performed in a bottom-up fashion.

At operation 502, a request to create an object within an account of the data system is received. A user of the account may request a creation of the object. For example, the request may be to create a materialized view of a table stored in schema A of a database 1 within the account.

At operation 504, one or more privilege checks associated with the user are performed. For example, a RBAC check of the user may be performed to determine whether the user has the appropriate privileges to access the table to create the materialized view. As discussed herein, feature policies provide a different security control than RBAC. RBAC and other privileges checks may be performed in conjunction with using feature policies. If one of the privilege checks fails, the creation of the object is blocked. If all privilege checks pass, then method 500 proceeds.

At operation 506, a feature policy associated with a first hierarchical level associated with the object is fetched (if there is a feature policy bound to the respective object) and checked. If there is no feature policy bound to the first hierarchical level, this operation is skipped.

In the example of a materialized view, a feature policy associated with the schema in which the table is created may be fetched and checked. The system may check whether a materialized view is on the blocked list (and/or allowed list) of the feature policy for the schema. If the materialized view is on the blocked list (or not in the allowed list), the creation of the materialized view is blocked. Alternatively or additionally, the feature policy for the object may be for a group or type of objects. In some examples, a first feature policy may be associated with a particular object, and a second feature policy may be associated with a type of objects to which the particular object belongs. For example, the second feature policy may be for a type of schemas, not just the particular schema. If the creation is not blocked by the particular feature policy, then the method 500 proceeds.

At operation 508, a feature policy associated with a second hierarchical level associated with the object is fetched (if there is a feature policy bound to the respective object) and checked. If there is no feature policy bound to the second hierarchical level, this operation is skipped.

Continuing with the example of the materialized view, a feature policy associated with the database is fetched and checked. The system may check whether a materialized view is on the blocked list (and/or allowed list) of the feature policy for the database (and/or types of that database). If the materialized view is on the blocked list (or not in the allowed list), the creation of the materialized view is blocked.

If the creation is not blocked by the particular feature policy, then the method 500 proceeds by checking the next hierarchical level until it reaches the last hierarchical level, which, in this case, is the account level.

At operation 510, a feature policy associated with a last hierarchical level associated with the object is fetched (if there is a feature policy bound to the respective object) and checked. Continuing with the example of the materialized view, a feature policy associated with the account is fetched and checked. The system may check whether a materialized view is on the blocked list (and/or allowed list) of the feature policy for the account. If the materialized view is on the blocked list (or not in the allowed list), the creation of the materialized view is blocked. If the creation is not blocked by the particular feature policy, the object is created at operation 512.

Feature policies allow a broad, hierarchical yet flexible control of features in an account. Consider an example of where an account has three databases storing customer data. The account may bind a feature policy to those three databases where creation of certain objects is blocked to ensure security and confidentiality protocols. However, the account may provide a fourth database for testing new products. A different feature policy can be bound to the fourth database, which allows creation of a broader type of objects. Thus, a development team may use the fourth database for developing and testing new products, and the account may still maintain proper control of the other three databases storing customer data.

In the examples described above, a user of an account is the actor attempting to create an object in the data system. However, in some instances, other non-user actors can attempt to create an object in the data system, which the administrator of the account may wish to block, such as applications (also referred to as "native applications").

As described herein, a data system (or cloud data platform), may include a plurality of different accounts. In some cases, a provider account can create an application. In some embodiments, the application may be what is referred to in the present disclosure as a "native platform application" or "native application," which, as used herein, refers to an application that is "built in" to-i.e., executes on-the herein-described data platform. An application may be considered a category of databases, such that an application may include schemas and database objects.

The provider account can share the application with one or more consumer accounts. In some of the described examples, both the data providers and the data consumers are customers of a common data platform, and accordingly each have a respective customer account (or just "account") on that data platform. In other embodiments, a given data provider and a given data consumer operate on separate platforms. Either or both of the separate platforms could be platforms operated by the data provider or data consumer themselves, or could be a customer account held by the data provider or the data consumer on another multi-customer data platform.

In some example embodiments, a given application may reside in the data-platform account of a provider account, and may include a set of application programming interfaces (APIs) that are associated with various underlying blocks of (e.g., source and/or executable) code provided by the given application. The underlying code blocks may perform operations that include, but are not limited to, particular queries, particular query operations (e.g., joins), user-defined functions, other functions, stored procedures, scripts, user-interface elements, secure views, and/or the like. In some examples, the provider account may share certain data with the application.

The provider account may further permit one or more consumer accounts to install an instance of the application. It is noted that there may be multiple data providers, multiple applications provided by a given data provider, multiple data consumers, multiple application instances installed by a given data consumer, and so forth. For simplicity, however, most of the examples that are described in the present disclosure involve a single data provider that has created a single application in the provider account, and a single consumer account that installs a single instance of that application in the consumer account.

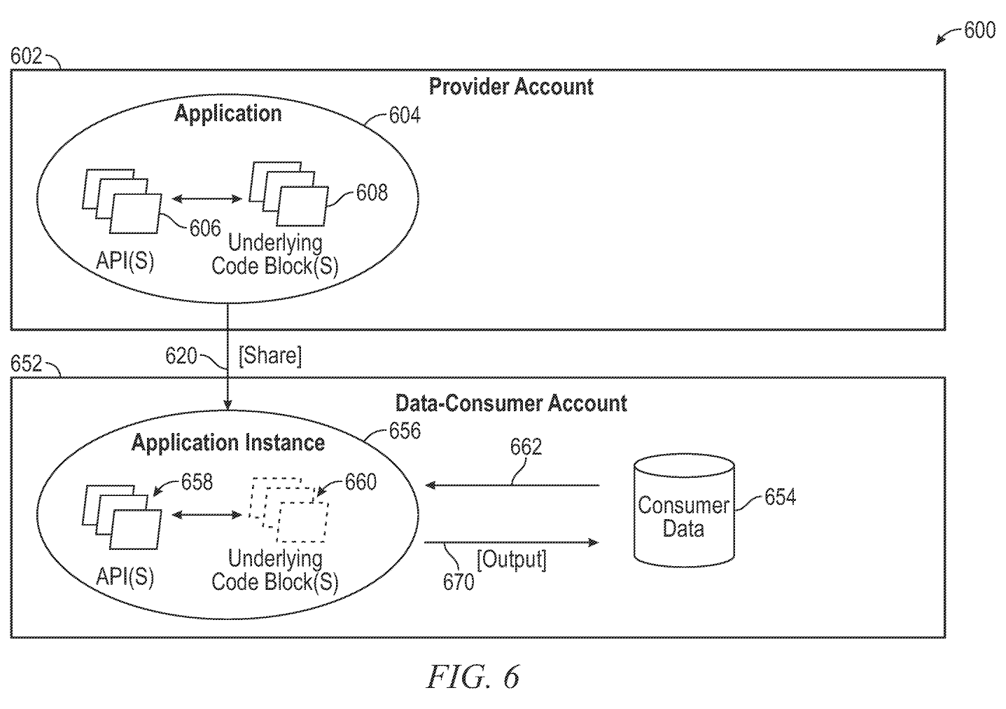

FIG. 6 depicts an example of a framework 600 for providing and sharing an application, according to some example embodiments. A provider account 602 generates and provides an application 604 (e.g., native application). The provider account 602 may also include provider data (not shown), such as one or more tables. The application 604 includes one or more APIs 606 that correspond with one or more respective underlying code blocks 608. The APIs 606 and associated underlying code blocks 608 may provide any of the operations described above, including queries, query operations (e.g., joins), user-defined functions, stored procedures, access to one or more secure views, generation of one or more user- interface elements, and/or the like. In some embodiments, the underlying code blocks 608 may contain the source code and/or executable code that performs the operations accessible via the APIs 606.

A share 620 depicts that the provider account 602 is sharing the application 604 with a consumer account 652. In some embodiments, sharing involves permitting the installation in the consumer account 652 of an application instance 656 of the application 604. The application instance 656 includes one or more APIs 658 that correspond to the one or more APIs 606 of the application 604. The APIs 658 respectively provide access to one or more underlying code blocks 660, which correspond to the one or more underlying code blocks 608 in the application 604. Whereas the underlying code blocks 608 (e.g., the underlying source code and/or executable code) are visible to the provider account 602, the underlying code blocks 660 are not visible to the consumer account 652-for this reason, the underlying code blocks 660 are depicted using dashed outlines in FIG. 6.

The consumer account 652 also contains consumer data 654. In some embodiments, the consumer account 652 may grant access to at least some of the consumer data 654 with the application instance 656. When the consumer account 652 uses one or more of the APIs 658 of the application instance 656, any output of these operations is depicted as being stored in the consumer data 654 of the data- consumer account 652. The security of the consumer data 654 is protected in at least two ways: the consumer data 654 stays in the consumer account 652 and is not exposed to the provider account 602, and the resulting output 670 is locally stored in the consumer account 652 and also not exposed to the provider account 602.

In some examples, the application instance 656 may attempt to create objects in the consumer account 652. The objects may be created within the application instance 656 or outside the application instance 656. For example, the application instance 656 may attempt to create a database outside of itself within the consumer account 652. Here, the application, not a particular user, is the actor creating the objects. Feature policies can be extended to handle these types of scenarios. For example, an administrator of an account may not want an application to have the ability to create certain objects while allowing or disallowing users to create the same type of objects. Feature policies may be created and bound to specific applications as well as types of applications within an account.

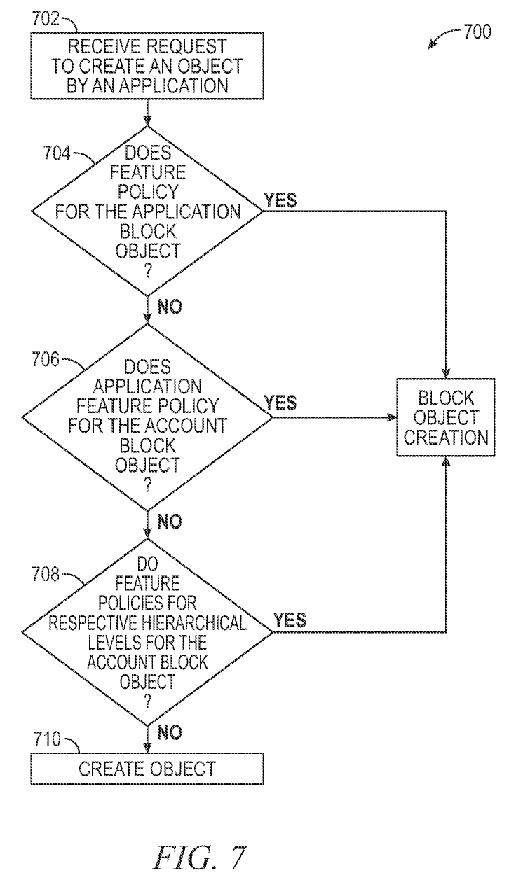

FIG. 7 is a flow diagram of a method 700 for enforcing feature policies with applications, according to some example embodiments. As mentioned above, one or more feature policies may be bound to applications and different hierarchical levels of the account. Enforcement of the respective feature policies may be performed in a bottom-up fashion.

At operation 702, a request to create an object by an application instance within an account of the data system is received. For example, an application instance installed in an account may attempt to create an object, such as a database, within the application instance or outside the application instance but within the account.

At operation 704, a feature policy associated with the application is fetched (if there is a feature policy bound to the respective application) and checked. If there is no feature policy bound to the application, this operation is skipped.

The system may check whether the requested object is on the blocked list (and/or allowed list) of the feature policy for the application. If the requested object is on the blocked list (or not in the allowed list), the creation of the object is blocked. If the creation is not blocked by the particular feature policy, then the method 700 proceeds.

At operation 706, an application feature policy bound to the account is fetched (if there is an application feature policy bound to the respective account) and checked. An application feature policy may be applicable to a group of applications, not just the particular application. The application feature policy may govern what can or cannot be created by types of applications in the account. If there is no application feature policy bound to the account, this operation is skipped.

The system may check whether the requested object is on the blocked list (and/or allowed list) of the application feature policy for the account. If the requested object is on the blocked list (or not in the allowed list), the creation of the object is blocked. If the creation is not blocked by the particular feature policy, then the method 700 proceeds.

Next, at operation 708, the system checks if the creation of the object is blocked by feature policies associated with the respective hierarchical levels of the account based on where the object is created, as described above with method 500 (e.g., operations 506-510). For example, if the requested object is a database, the system may check if any feature policy associated with the database (and/or database type) and account block the creation of the object. If the requested object is on a blocked list (or not in the allowed list) of any of the relevant feature policies, the creation of the object is blocked. If the creation is not blocked by any of the feature policies, the object is created at operation 710.

Ownership transfers or moving objects to different locations may be treated similarly to creating objects, and therefore feature policies may be enforced to control ownership transfers and movement of objects. That is, when an object is being moved from location to another (e.g., DB 1 to DB2), the system may check relevant feature policies to determine whether the move of the object to the new location is blocked as described above for the creation of objects. Therefore, moving or transferring an object into a domain where creating the object would be blocked by a feature policy would also be similarly denied by the feature policy.

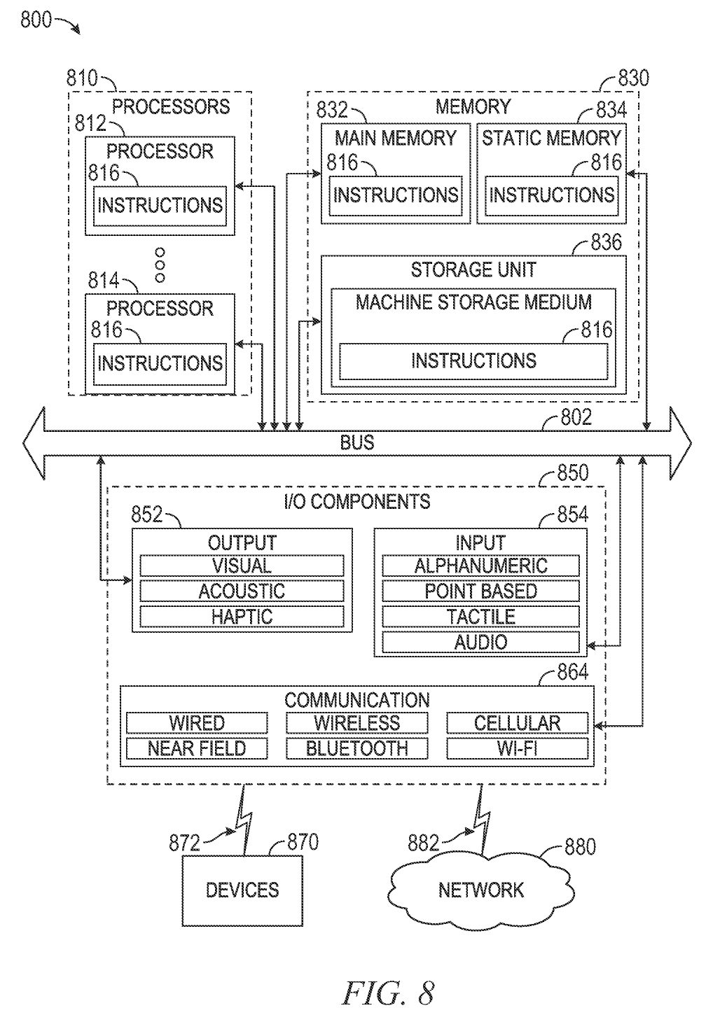

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., a software, a program, an application, an applet, an app, or other executable code) for causing the machine 800 to perform any one or more of the methodologies discussed herein may be executed. For example, the instructions 816 may cause the machine 800 to execute any one or more operations of the methods described herein. As another example, the instructions 816 may cause the machine 800 to implement any one or more portions of the functionality illustrated in any one of figures described herein. In this way, the instructions 816 transform a general, non-programmed machine into a particular machine that is specially configured to carry out any one of the described and illustrated functions of the cloud data platform 102 such as the compute service manager 108 (or a component thereof such as the application specification manager 109) or an execution node of the execution platform 110.

In some embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term "machine" shall also be taken to include a collection of machines 800 that individually or jointly execute the instructions 816 to perform any one or more of the methodologies discussed herein.

The machine 800 includes processors 810, memory 830, and I/O components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio- frequency integrated circuit (RFIC), another processor, or any suitable combination thereof) may include, for example, a processor 814 and a processor 812 that may execute the instructions 816. The term "processor" is intended to include multi-core processors 810 that may comprise two or more independent processors (sometimes referred to as "cores") that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 870 may include the data store 206 or any other computing device described herein as being in communication with the cloud data platform 102 or the data storage 104.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms "machine-storage medium," "device-storage medium," and "computer-storage medium" mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms "machine-storage medium," "computer- storage medium," and "device-storage medium" specifically exclude carrier waves, modulated data signals, and other such media, at least some of which are covered under the term "signal medium" discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms "transmission medium" and "signal medium" mean the same thing and may be used interchangeably in this disclosure. The terms "transmission medium" and "signal medium" shall be taken to include any intangible medium that is capable of storing, encoding, or carrying the instructions 816 for execution by the machine 800, and include digital or analog communications signals or other intangible media to facilitate communication of such software. Hence, the terms "transmission medium" and "signal medium" shall be taken to include any form of modulated data signal, carrier wave, and so forth. The term "modulated data signal" means a signal that has one or more of its characteristics set or changed in such a manner as to encode information in the signal.

The terms "machine-readable medium," "computer-readable medium," and "device-readable medium" mean the same thing and may be used interchangeably in this disclosure. The terms are defined to include both machine- storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the method 500 may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms "a" or "an" are used, as is common in patent documents, to include one or more than one, independent of any other instances or usages of "at least one" or "one or more." In this document, the term "or" is used to refer to a nonexclusive or, such that "A or B" includes "A but not B," "B but not A," and "A and B," unless otherwise indicated. In the appended claims, the terms "including" and "in which" are used as the plain-English equivalents of the respective terms "comprising" and "wherein." Also, in the following claims, the terms "including" and "comprising" are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving a request to create an object within an account of a multi-tenant network-based database system; retrieving a first feature policy bound to a first hierarchical level associated with the object; determining whether creation of the object is blocked based on the first feature policy; and blocking or allowing creation of the object based on determining whether the object is blocked based on the first feature policy.

Example 2. The method of example 1, wherein the first feature policy does not block creation of the object, the method further comprising: retrieving a second feature policy bound to a second hierarchical level associated with the object, the second hierarchical level being above the first hierarchical level; determining whether creation of the object is blocked based on the second feature policy; and blocking or allowing creation of the object based on determining whether the object is blocked based on the second feature policy.

Example 3. The method of any of examples 1-2, wherein the first feature policy is an independent object bound to the first hierarchical level.

Example 4. The method of any of examples 1-3, further comprising: unbinding the first feature policy from the first hierarchical level; and binding a second feature policy to the first hierarchical level.

Example 5. The method of any of examples 1-4, wherein the first feature policy is bound to at least one other hierarchical level within the account.

Example 6. The method of any of examples 1-5, wherein the request is received from a user of the account.

Example 7. The method of any of examples 1-6, further comprising: performing a role-based access control privilege check based on the user.

Example 8. The method of any of examples 1-7, wherein the request is received from an application installed in the account.

Example 9. The method of any of examples 1-8, further comprising: retrieving a second feature policy associated with the application; determining whether creation of the object is blocked based on the second feature policy; and blocking or allowing creation of the object based on determining whether the object is blocked based on the second feature policy.

Example 10. A system comprising: one or more processors of a machine; and a memory storing instructions that, when executed by the one or more processors, cause the machine to perform operations implementing any one of example methods 1 to 9.

Example 11. A machine-storage medium embodying instructions that, when executed by a machine, cause the machine to perform operations implementing any one of example methods 1 to 9.

What is claimed is:

1. A system comprising:
at least one hardware processor; and
at least one memory storing instructions that cause the at least one hardware processor to perform operations comprising:
receiving a request to create an object within an account of a multi-tenant network-based database system;
retrieving a first feature policy bound to a first hierarchical level associated with the object;
determining whether creation of the object is blocked based on the first feature policy; and
blocking or allowing creation of the object based on determining whether the object is blocked based on the first feature policy.

2. The system of claim 1, wherein the first feature policy does not block creation of the object, the operations further comprising:
retrieving a second feature policy bound to a second hierarchical level associated with the object, the second hierarchical level being above the first hierarchical level;
determining whether creation of the object is blocked based on the second feature policy; and
blocking or allowing creation of the object based on determining whether the object is blocked based on the second feature policy.

3. The system of claim 1, wherein the first feature policy is an independent object bound to the first hierarchical level.

4. The system of claim 3, the operations further comprising:
unbinding the first feature policy from the first hierarchical level; and
binding a second feature policy to the first hierarchical level.

5. The system of claim 3, wherein the first feature policy is bound to at least one other hierarchical level within the account.

6. The system of claim 1, wherein the request is received from a user of the account.

7. The system of claim 6, the operations further comprising:
performing a role-based access control privilege check based on the user.

8. The system of claim 1, wherein the request is received from an application installed in the account.

9. The system of claim 8, the operations further comprising:
retrieving a second feature policy associated with the application;
determining whether creation of the object is blocked based on the second feature policy; and
blocking or allowing creation of the object based on determining whether the object is blocked based on the second feature policy.

10. A method comprising:
receiving a request to create an object within an account of a multi-tenant network-based database system;
retrieving a first feature policy bound to a first hierarchical level associated with the object;
determining whether creation of the object is blocked based on the first feature policy; and
blocking or allowing creation of the object based on determining whether the object is blocked based on the first feature policy.

11. The method of claim 10, wherein the first feature policy does not block creation of the object, the method further comprising:
retrieving a second feature policy bound to a second hierarchical level associated with the object, the second hierarchical level being above the first hierarchical level;
determining whether creation of the object is blocked based on the second feature policy; and
blocking or allowing creation of the object based on determining whether the object is blocked based on the second feature policy.

12. The method of claim 10, wherein the first feature policy is an independent object bound to the first hierarchical level.

13. The method of claim 12, further comprising:
unbinding the first feature policy from the first hierarchical level; and
binding a second feature policy to the first hierarchical level.

14. The method of claim 12, wherein the first feature policy is bound to at least one other hierarchical level within the account.

15. The method of claim 10, wherein the request is received from a user of the account.

16. The method of claim 15, further comprising:
performing a role-based access control privilege check based on the user.

17. The method of claim 10, wherein the request is received from an application installed in the account.

18. The method of claim 17, further comprising:
retrieving a second feature policy associated with the application;
determining whether creation of the object is blocked based on the second feature policy; and
blocking or allowing creation of the object based on determining whether the object is blocked based on the second feature policy.

19. A machine-storage medium embodying instructions that, when executed by a machine, cause the machine to perform operations comprising:
receiving a request to create an object within an account of a multi-tenant network-based database system;
retrieving a first feature policy bound to a first hierarchical level associated with the object;
determining whether creation of the object is blocked based on the first feature policy; and
blocking or allowing creation of the object based on determining whether the object is blocked based on the first feature policy.

20. The machine-storage medium of claim 19, wherein the first feature policy does not block creation of the object, the operations further comprising:
retrieving a second feature policy bound to a second hierarchical level associated with the object, the second hierarchical level being above the first hierarchical level;
determining whether creation of the object is blocked based on the second feature policy; and
blocking or allowing creation of the object based on determining whether the object is blocked based on the second feature policy.
